(19) United States
(12) Patent Application Publication
(10) Pub. No.: US 2009/0254684 A1
(43) Pub. Date: Oct. 8, 2009

(54) Peripheral electronic device with USB connectivity storage apparatus

(76) Inventor: Thomas Willis, Franconia, NH (US)

Correspondence Address: Law Offices Eric R. Benson,Esq., 6A Hillside Lane, Westford, VT, 05494-9769, US

(21) Appl. No.: 12/383,346

(22) Filed: Mar. 23, 2009

Related U.S. Application Data
(60) Provisional application No. 61/070,529, filed on Mar. 24, 2008.

(51) Int. Cl. G06F 13/38

(52) U.S. Cl. 710/63

(57) ABSTRACT

This invention relates to a combination storage device with at least one to several small recessed areas cut or molded into the device whereby the device may receive and store one or more flash drives, “memory sticks” or data sticks with USB connectivity by means of accepting the standardized dimension of the male end of such USB devices. This device further provides connectivity from stored peripheral electronic devices to user selected electronic devices.

### BACKGROUND ART

The trend in the electronics revolution is to make electronic devices smaller and smaller. From mp3 players to computers to phones to storage devices the electronic consumer cannot seem to get enough of these miniature devices and the smaller the better. One such device, the flash drive or so called memory stick, has revolutionized the data storage industry. School children in the early grades of grammar school are routinely using these devices to store their school work, and not to mention their music and other forms of entertainment as well.

While such miniaturization has had incredible benefits it does have a significant drawback. These “tiny” devices are very easy to lose or end up in places where they are destroyed. It is not uncommon for a person to own several “memory sticks” that find their way into junk drawers, pockets, pet food dishes and places other than where a user can find them easily when needed.

The last thing such a memory stick user needs is yet another device to clutter their desk or computer station. The present invention incorporates a common existing storage device on most people's desks, that of a pen and pencil or memo pad storage device and combine it with a means of storing USB memory sticks. Various styles of such combinations devices could be fashioned and from various materials. Each combination desk accessory would have at least one to several small recessed areas cut or molded into the storage device whereby receiving one or more of these flash drives or data sticks by means of the standardized dimension, the male end of the peripheral USB device.

There is a growing need for such a novel device. As consumers buy and use more than one such USB device, there is also a growing need to store and handle such devices. Currently in the marketplace these types of USB devices commonly have lanyards attached to their opposite end of the USB plug and typically only hold one such device. More consumers are aware of the convenience of dividing their storage needs into categories and are typically buying more than one device. One USB data stick may hold a music library, another may hold personal documents, and still another work or job related information.

Future needs may deem it necessary to have such storage devices in many different locations including motor vehicles as the technology moves further away from CDs or DVDs.

There are no acceptable prior art memory stick storage devices that minimize the need of utilizing additional space nor are any such devices that incorporate such storage with other common desktop storage devices such as pen and pencil or memo holders or other similar office accessories. Similarly there are no acceptable prior art memory stick storage devices that could be used in other settings such as in an automobile or other such non-office setting.

While each prior art storage device may fulfill their respective particular objectives and requirements, and are most likely quite functional for their intended purposes, it will be noticed that none of the prior art cited disclose an apparatus that is incorporated with other storage means to meet the storage requirements or restrictions of a user. As such, there apparently still exists the need for new and improved memory stick storage device to maximize the benefits to the user and minimize the space occupied from its use. The current invention addresses all of these issues to provide a technology that provides a much more effective, efficient and user friendly device.

In this respect, the present invention disclosed herein substantially corrects these problems and fulfills the need for such a device.

### DISCLOSURE OF THE INVENTION

In view of the foregoing limitations inherent in the known types of “memory stick” or data stick storage devices now present in the prior art, the present invention provides an apparatus that has been designed to provide the following features for a user:
An easy to use USB compatible storage device.
To minimize the need for multiple storage means this device incorporates other storage needs, i.e. pens, pencils and memo pads such as “Post-It Notes@”, etc.
Maximum visibility of the stored devices.

These features are improvements which are patently distinct over similar devices and methods which may already be patented or commercially available. As such, the general purpose of the present invention, which will be described subsequently in greater detail, is to provide a field designed apparatus that incorporates the present invention. There are many additional novel features directed to solving problems not addressed in the prior art.

The advances of computer technology have been astounding in several important respects. Largely driven by consumer demand, computers have become significantly larger in capacity while at the same time the computers themselves have become smaller with an increased portability. Concomitantly the need arose for the ability to store large amounts of memory on smaller and smaller portable storage devices. These need coupled with the technology of USB computer connectivity has given rise to what has been called in the industry as “memory sticks.”

In recent practice, consumers have tended to own very few, if not only one, such memory stick. However, as the price of these devices have declined and the need for portable memory capacity have increased, more and more consumers now own more than one, if not several of these memory sticks. The consequence of this increase demand and decrease in size for and of these devices is that they are easily lost and difficult to find. Since most computers utilize various USB ports for device connectivity, such as other computers, faxes, and printers, etc., there is generally little to no storage for memory sticks on most personal computers.

There appears to be a need in the art for a durable, easily accessible memory stick storage device that would permit a user to easily store and find for use a large number of such devices. Such storage devices could easily be utilized as a switched or un-switched device with its own connectivity to one or more devices for electronic access to such devices. In the mode of a simple storage device the invention comprises a material of suitable stability and rigidity to accept at least one of the male end of a USB plug end of a memory stick into said material which has disposed therein a female port capable of accepting said male end such that the memory stick would be held therein by a friction fit.

In the preferred embodiment disclosed herein and as more particularly illustrated on the attached drawings, an office supply desktop holder, constructed from high quality hardwood is used, and disposed therein is a plurality of female USB shaped ports, into which the memory stick male ends may be inserted for storage as depicted in said drawing. In the most preferred embodiment as illustrated the holder would be rotatably mounted on a base that would permit the holder to be turned in place without the need to pick up the device, thereby permitting the easy insertion and removal of memory sticks about the entire circumference of the holder.

It would be obvious to one skilled in the art to construct this device in different shapes and sizes. Similarly it would be obvious to manufacture this device out of some other material like that of plastic, metal, ceramic or composite. Also, it would be obvious to integrate the function of storage with that of connectivity by electronically interfacing the storage unit with one or more devices for use.

To attain this the present invention generally comprises three major components: 1) At least one Peripheral Electronic Device Host Receptacle; 2) At least one Article Storage Compartment; and 3) An electronic connectivity means from the storage device to user selected electronic devices.

These together with other objects of the invention, along with the various features of novelty which characterize the invention, are pointed out with particularity in the claims which are annexed to and form a part of this patent application. For a better understanding of the invention, its operating advantages and the specific objects attained by its uses, reference should be had to the accompanying drawings and descriptive matter in which there is illustrated preferred embodiments of the invention.

### BRIEF DESCRIPTION OF THE DRAWINGS

FIG. 1 is perspective view of the Peripheral Electronic Device with USB Connectivity Storage Apparatus combination with a memo pad, pen and pencil storage embodiment.

FIG. 2 is a perspective view of the Peripheral Electronic Device with USB Connectivity Storage Apparatus combination with a circular swiveling pen and pencil storage.

FIG. 3 is perspective view of the Peripheral Electronic Device with USB Connectivity Storage Apparatus combination with a memo pad, pen and pencil storage embodiment and a peripheral USB Port for connectivity to user selected electronic devices.

### BEST MODES FOR CARRYING OUT THE INVENTION

### I. Preferred Embodiments

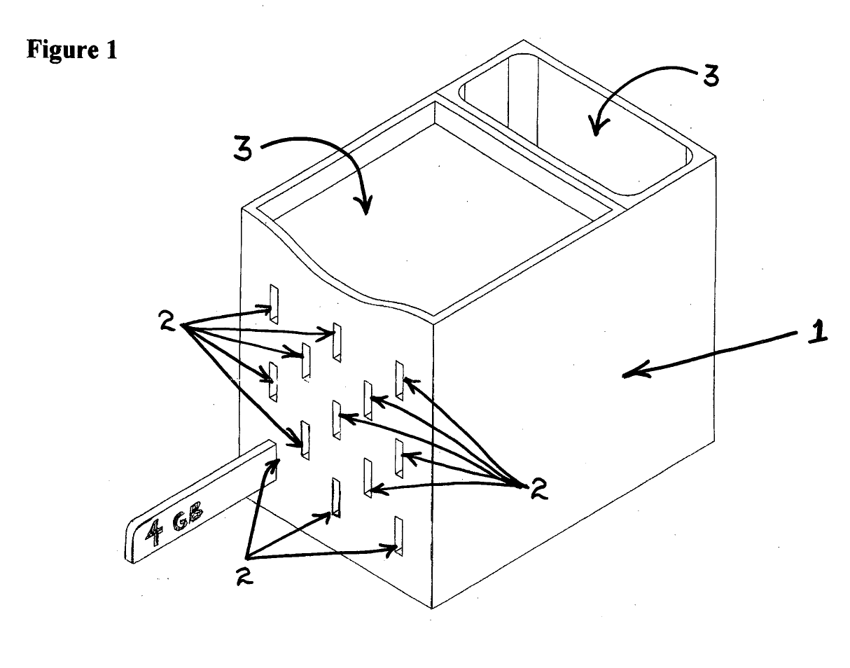

With reference now to the drawings, and in particular to FIGS. 1-3 thereof, a new and novel Peripheral Electronic Device with USB Connectivity Storage Apparatus (1) embodying the principles and concepts of the present invention is depicted in these drawings as comprising three major components, at least one Peripheral Electronic Device Host Receptacle (2), at least one Article Storage Compartment (3); and at least one USB Port (5) allowing connection to user selected electronic devices.

### General Description of Reference Numerals in the Description and Drawings

Any actual dimensions listed are those of the preferred embodiment. Actual dimensions or exact hardware details and means may vary in a final product or most preferred embodiment and should be considered means for so as not to narrow the claims of the patent.

List and Description of component parts of the invention:
(1) Peripheral Electronic Device with USB Connectivity Storage Apparatus
(2) Peripheral Electronic Device Host Receptacle
(3) Article Storage Compartment
(4) Swivel Base
(5) USB Port
(6) Electronic Connector

In the preferred embodiment the Peripheral Electronic Device with USB Connectivity Storage Apparatus (1) is made of high quality decorative hardwood of whatever species a user prefers. At least one orifice is formed in the Peripheral Electronic Device with USB Connectivity Storage Apparatus (1) of a suitable size such that a USB compatible Peripheral Electronic Device Host Receptacle (2) may be securely placed therein. Once the Peripheral Electronic Device Host Receptacle(s) (2) are in place the user may store memory sticks or other USB compatible peripheral devices therein. To aid in identification of individual memory sticks that are stored in the device that hold more than one a label means can easily be added whereby a user could then easily select the correct memory stick desired having been stored in a labeled Peripheral Electronic Device Host Receptacle (2).

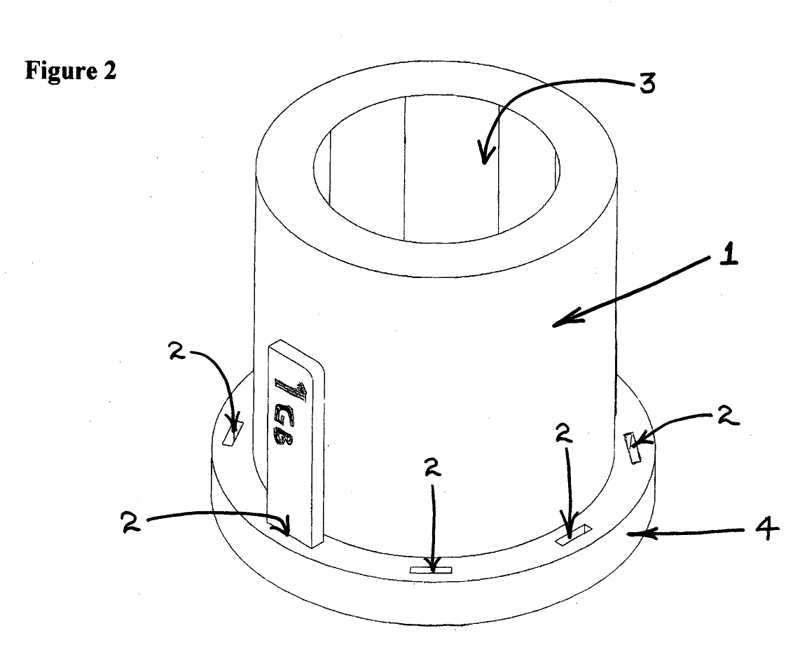

Additionally at least one orifice is formed in the Peripheral Electronic Device with USB Connectivity Storage Apparatus (1) of a suitable size to form an Article Storage Compartment (3). The Article Storage Compartment (3) is formed according to the user's desired storage needs which include any desired objects from desktop objects to office supplies to automotive needs such as a beverage holder or memo pads etc. The embodiment depicted in FIG. 2 is able to store memory stocks vertically around a circular storage compartment that rotates for easy selection and storage by means of a Swivel Base (4).

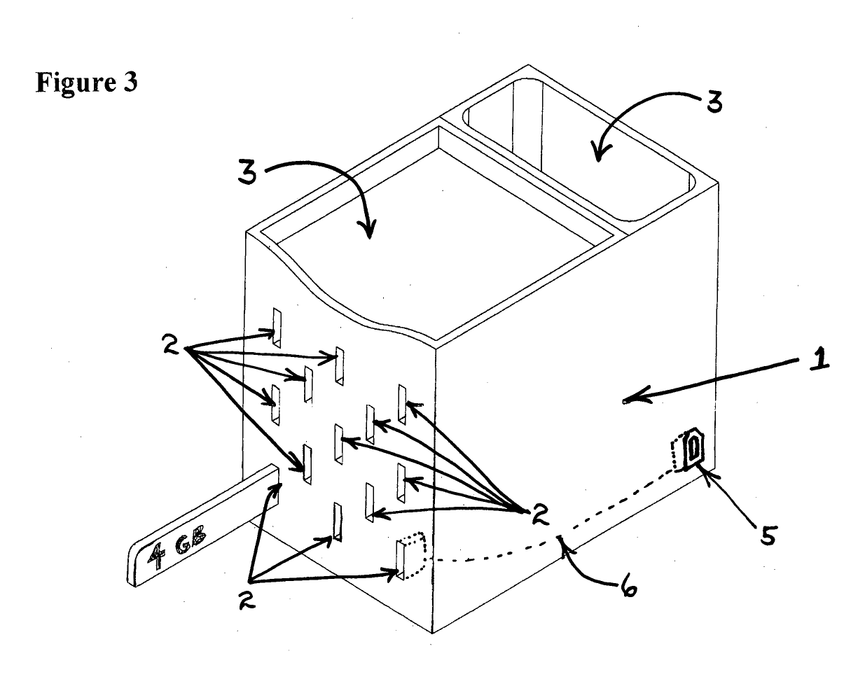

FIG. 3 depicts the Peripheral Electronic Device Host Receptacle (2) in electronic communication by means of an Electronic Connector (6) to the USB Port (5) such that when a peripheral USB compatible electronic device, such as a “memory stick” is stored in the Peripheral Electronic Device with USB Connectivity Storage Apparatus (1) a user may establish electronic communication with the peripheral USB compatible electronic device and any user selected electronic device by connecting the selected electronic device to the USB Port (5).

It would be obvious to one skilled in the art to incorporate a computer interface with this device whereby the computer would be able to access the information contained on the stored memory sticks as depicted in FIG. 3. Similarly, it would be obvious to one skilled in the art to incorporate an electronic device in the Peripheral Electronic Device with USB Connectivity Storage Apparatus (1) whereby the device itself could read and display the content of the stored memory stick or even display or play video, pictures or sound and music.

It would also be obvious in one skilled in the art to manufacture the Peripheral Electronic Device with USB Connectivity Storage Apparatus (1) out of any other suitable material such as plastic, metal, ceramic or other composite material. Similarly, the Article Storage Compartment (3) can be designed to store virtually any article a user may desire, depending upon where the device will be used and what articles would require storage in such locations.

While my above descriptions of the invention, its parts, and operations contains many specificities, these should not be construed as limitations on the scope of the invention, but rather as exemplifications of present embodiments thereof. Many other variations are possible, for example, other embodiments, shapes, and sizes of the device can be constructed and designed to work by the principles of the present invention; various materials, colors and configurations can be employed in the device's design that would provide interesting embodiment differences to users.

Accordingly, the scope of the invention should be determined not by the embodiments illustrated, but by the claims and their legal equivalents as filed herewith.

Having described my invention, I claim:

1. A peripheral electronic device with USB connectivity storage apparatus comprised of:
a rigid material; and
the rigid material being further comprised of at least one host receptacle wherein the host receptacle is able to have inserted therein a male end of a peripheral electronic device with USB connectivity such that the peripheral electronic device upon insertion in the host receptacle will remain in the host receptacle unless removed by a user.

2. A peripheral electronic device with USB connectivity storage apparatus comprised of:
a rigid material;
the rigid material being further comprised of at least one host receptacle wherein the host receptacle is able to have inserted therein a male end of a peripheral electronic device with USB connectivity such that the peripheral electronic device upon insertion in the host receptacle will remain in the host receptacle unless removed by a user; and
the rigid material being further comprised of at least one storage compartment.

3. A peripheral electronic device with USB connectivity storage apparatus comprised of
a rigid material;
the rigid material being further comprised of at least one host receptacle wherein the host receptacle is able to have inserted therein a male end of a peripheral electronic device with USB connectivity such that the peripheral electronic device upon insertion in the host receptacle will remain in the host receptacle unless removed by a user;
the rigid material being further comprised of at least one storage compartment; and
a rotating means attached to the rigid material whereby a user may rotate the memory stick storage device without having to lift the memory stick storage device to accomplish a user desired rotation.

4. The peripheral electronic device with USB connectivity storage apparatus of claim 1 wherein the rigid material is selected from the group consisting of wood, plastic, metal, glass, ceramic or composites thereof.

5. The peripheral electronic device with USB connectivity storage apparatus of claim 2 wherein the rigid material is selected from the group consisting of wood, plastic, metal, glass, ceramic or composites thereof.

6. The peripheral electronic device with USB connectivity storage apparatus of claim 3 wherein the rigid material is selected from the group consisting of wood, plastic, metal, glass, ceramic or composites thereof.

7. The peripheral electronic device with USB connectivity storage apparatus of claim 1 wherein the host receptacle is a female end of a host portion of a USB interface.

8. The peripheral electronic device with USB connectivity storage apparatus of claim 2 wherein the host receptacle is a female end of a host portion of a USB interface.

9. The peripheral electronic device with USB connectivity storage apparatus of claim 3 wherein the host receptacle is a female end of a host portion of a USB interface.

10. The peripheral electronic device with USB connectivity storage apparatus of claim 2 wherein the storage compartment is capable of holding therein user selected articles.

11. The peripheral electronic device with USB connectivity storage apparatus of claim 3 wherein the storage compartment is capable of holding therein user selected articles.

12. The peripheral electronic device with USB connectivity storage apparatus of claim 7 wherein the host portion of the USB interface may be placed in electronic communication with a user selected electronic device such that the user selected electronic device may thereby be enabled to electronically communicate with a peripheral electronic device with USB connectivity when stored in the peripheral electronic device with USB connectivity storage apparatus.

13. The peripheral electronic device with USB connectivity storage apparatus of claim 8 wherein the host portion of the USB interface may be placed in electronic communication with a user selected electronic device such that the user selected electronic device may thereby be enabled to electronically communicate with a peripheral electronic device with USB connectivity when stored in the peripheral electronic device with USB connectivity storage apparatus.

14. The peripheral electronic device with USB connectivity storage apparatus of claim 9 wherein the host portion of the USB interface may be placed in electronic communication with a user selected electronic device such that the user selected electronic device may thereby be enabled to electronically communicate with a peripheral electronic device with USB connectivity when stored in the peripheral electronic device with USB connectivity storage apparatus.

15. The peripheral electronic device with USB connectivity storage apparatus of claim 1 wherein the peripheral electronic device with USB connectivity is a USB compatible mass storage device commonly referred to as a memory stick.

16. The peripheral electronic device with USB connectivity storage apparatus of claim 2 wherein the peripheral electronic device with USB connectivity is a USB compatible mass storage device commonly referred to as a memory stick.

17. The peripheral electronic device with USB connectivity storage apparatus of claim 3 where in the peripheral electronic device with USB connectivity is a USB compatible mass storage device commonly referred to as a memory stick.
